(19) United States
(12) Patent Application Publication
(10) Pub. No.: US 2005/0115143 A1
(43) Pub. Date: Jun. 2, 2005

(54) Device and method for arranging a longline including bait in a longline container

(76) Inventors: Kolbjorn Bjorshol, Averoy (NO); Harald Kare Staurnes, Averoy (NO)

Correspondence Address: SHANKS & HERBERT, 1301 K STREET, N.W., SUITE 1100 - EAST TOWER, WASHINGTON, DC, 20005, US

(21) Appl. No.: 10/506,545

(22) PCT Filed: Mar. 5, 2003
(86) PCT No.: PCT/NO03/00075

(30) Foreign Application Priority Data
Mar. 5, 2002 (NO) 20021097

(51) Int. Cl. A01K 91/18

(52) U.S. Cl. 43/27.4

(57) ABSTRACT

The invention refers to a method for transferal of a longline hook with bait (5) from a baiting machine (6) into a longline container (12), where the hook is connected to the longline (3) via a snood (4), as the longline (3) is set up to be arranged in a longline chamber in the longline container while the hook/bait (5) is transferred to a hook/bait chamber (16) adjacent to the longline chamber. The method according to the invention is characterised in that, as the longline (3) is conducted from the baiting machine to the longline chamber via a conductor device, the hook with bait (5) is simultaneously transferred in an initial manoeuvre to a holder (8), as the holder (8) with the hook/bait (5) is located at an intermediate station directly above the longline container (12), or is transferred to such an intermediate station and then transferred via a conductor device from the holder to the hook/bait chamber (16) in the longline container. The invention also refers to a device for execution of the method.

The present invention here concerns a method for transferral of a longline hook with bait from a baiting machine into a longline container, where the hook is connected to the longline via a snood, as the longline is set up to be arranged in a longline chamber in the longline container while the hook/bait is placed in a hook/bait chamber adjacent to the longline chamber. The invention also concerns a device.

Previously, attempts have been made to automate the handling of baiting longlines with hooks which are fastened to the longline with a snood. However, these attempts have failed to produce a system which is operationally reliable with regard to placing a baited hook in the correct place in the longline container.

The present invention aims to provide a new and operationally reliable system for arranging a longline with baited hook in a snood into a storage vessel (container).

The device according to the invention is characterised in that, as the longline is conducted from the baiting machine to the longline chamber via a conductor device, the hook with bait is simultaneously transferred in a first initial manoeuvre to a holder, as the holder with the hook/bait is located at an intermediate station directly above the longline container, or is transferred to such an intermediate station, whereafter a conductor device transfers the hook with bait from the holder to the hook/bait chamber in the longline container.

The preferred implementations of the method are specified in the independent claims 2-9.

The device according to the invention is characterised by a holder arranged to collect the hook with bait from the baiting machine, in that the hoder with the positioned hook with bait then already is In, or Is arranged to be transferred to an intermediate station, and a conductor device arranged to help transfer the hook with bait from the holder to the hook/bait chamber in the longline container.

The preferred implementations of the device are characterised by the features defined in the characteristic clause of the subsequent claims 11-17.

The invention shall now be described in more detail, with reference to the following figures, in which:

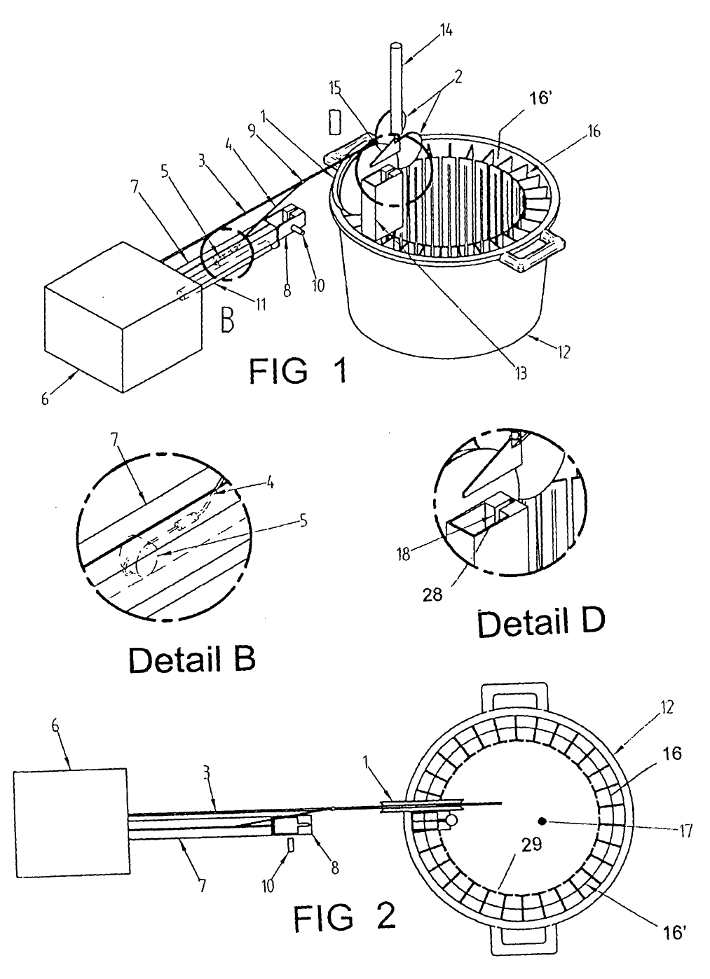

FIG. 1 illustrates a perspective sketch of the device according to the invention, in connection with the positioning of a baited snood hook in a longline container.

FIG. 1B illustrates a detail of the conducting of the fishing hook towards a holder (8).

FIG. 1C illustrates a magnification of a detail from FIG. 1, i.e. a device which conducts the hook/snood down into the longline container.

FIG. 2 illustrates a plan sketch of the device according to FIG. 1.

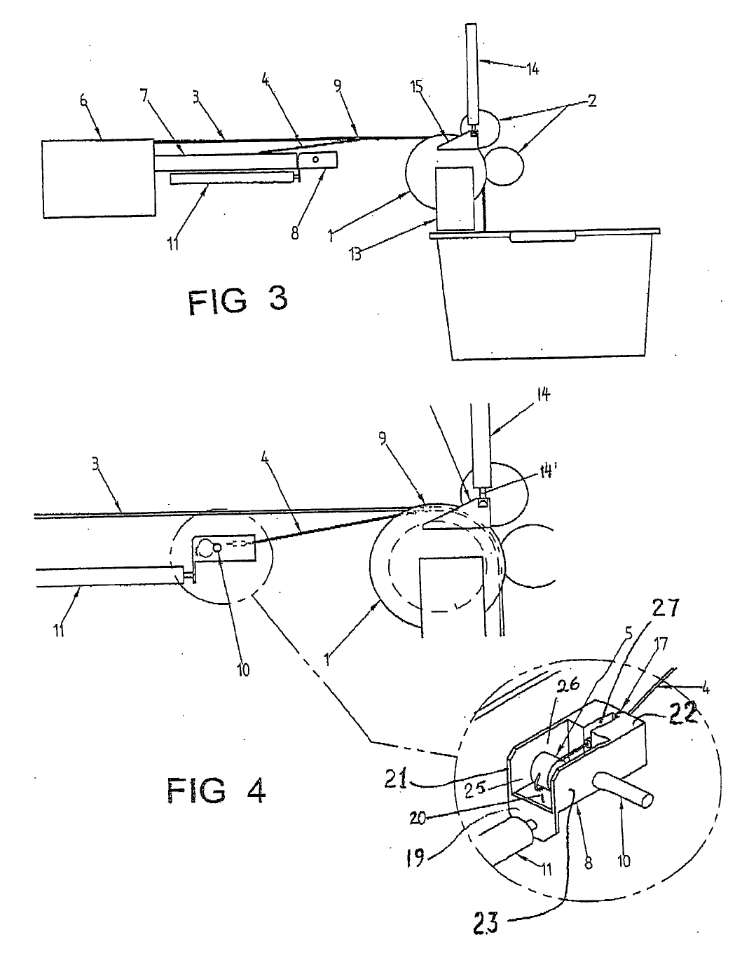

FIG. 3 illustrates a side elevation of the device according to FIG. 1.

FIG. 4 illustrates a magnified side elevation of FIG. 3.

FIG. 4A illustrates a magnification in perspective of the holder 8).

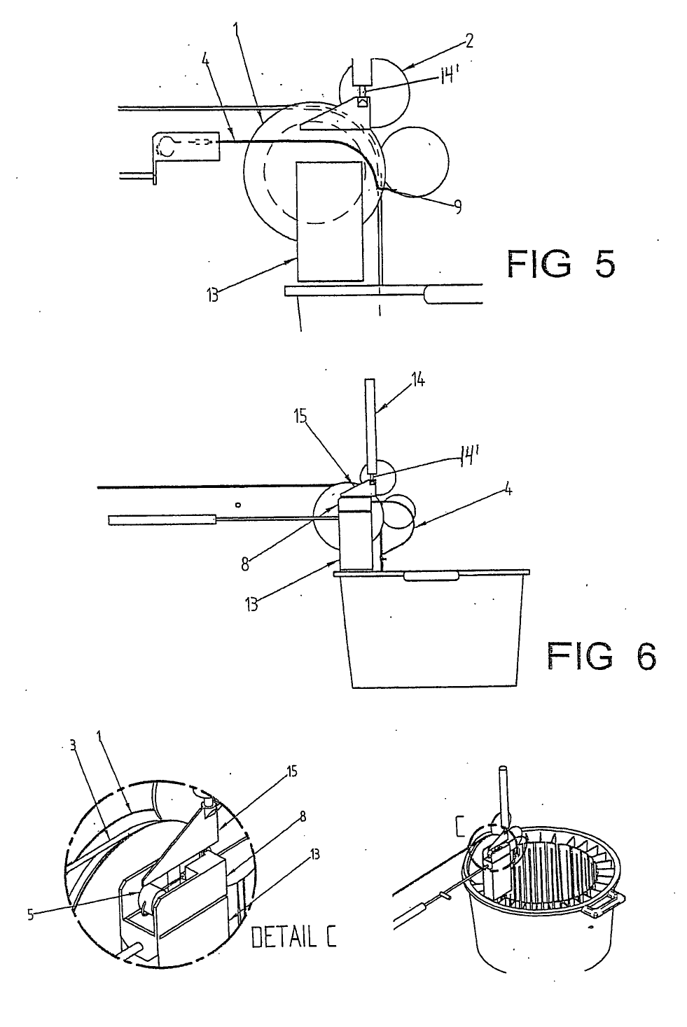

FIG. 5 illustrates a magnification of a detail from FIG. 4 of the holder in an intermediate position.

FIG. 6 illustrates a side elevation of a detail from FIG. 3, i.e. the longline container with transferral device and the device for positioning of the fish hook with bait.

FIG. 6A illustrates a perspective sketch of the holder in position for further (at next stage) downward transferral of the fish hook with bait.

FIG. 6B illustrates a magnification of the holder in the position according to FIG. 6A.

The device/apparatus according to FIGS. 1-3 involves a system for transferral of a hook with bait 5 in a longline snood 4 from a baiting machine 6 and to a longline container 12. This transferral process takes place in two stages, as follows:

The first stage, where the hook/bait 5 is fastened to a holder 8 which is then moved forwards to an intermediate position roughly directly (vertically) over the position where the hook/bait 5 is stored in the longline container 12. Alternatively, the holder may already be in the above-mentioned intermediate position, i.e. it does not need to be moved further.

The second stage, where the hook/bait 5 is ejected from the holder, preferably vertically downwards and to storage in the longline container.

The figures schematically illustrate a baiting machine 6 which places bait on each hook 5 on the longline system. The longline 3 is mainly transported horizontally over a rotating longline disk 1 with a V groove shape which is positioned just above one edge of the longline container 12. Spring-loaded compression wheels 2 help keep the longline 3 tight as it moves down into the V groove, and help to pull the longline out from the baiting machine over the longline disc and down into the rope receptacle 17 In the container.

The longline disc 1 Is positioned so that when the longline 3 comes out of the longline disc 1, it descends into the rope receptacle 17 in the container 12.

Each snood 4 fastening to the longline 3 is illustrated by position 9. As illustrated in FIG. 2 (plan cross-section), the hook with bait is transferred forwards at a distance from the actual longline 3, so that the snood runs inclined from the hook and forwards (possibly slightly upwards) to the fastening 9 in the longline 3.

A holder 8 is mounted on a fitting in connection with the actual baiting machine 6. The holder is arranged to capture and hold on to the hook with bait 5 and is moved forwards in the direction of the container at the same rate as the pull on the longline 3.

The holder 8 is fastened to the end of the piston rod 11 in a piston/cylinder unit where the cylinder unit (not Illustrated) is fastened to the baiting housing.

The holder 8 (see FIG. 4) is made of a quadrilateral framework of parallel and vertical plates 21, 23, 22, 19 which are arranged at mutual distances. This forms a housing with an internal chamber 26 with open top and bottom. One of the end walls (the peripheral wall 22) is split into two parts by two mutually level, straight-through, vertical, run-through slots 17 and 27. The innermost slot 27 is wider than the peripheral outermost slot 17. The other end wall is formed as a flap-like plate 19 to which the exterior end of the piston 11 is attached. However, this flap 19 extends downwardly below the parallel plates so that the housing's innermost end (25) Is also open and forms an entrance for the hook/bait to the holder 8.

This implies that when the hook with bait is pulled into the housing, the snood 4 runs in and down into slot 17. Slot 17 is, however, more narrow than the eye of the hook to which the snood is attached, and thus the hook will stop when the eye hits/is pulled against the back wall. This is illustrated in FIG. 4, which shows the hook with bait 5 positioned in the chamber 26. The section of the hook stem up to the eye lies in the wider slot 27 while the snood runs through slot 17, out of the holder 8 and towards the fastening 9 on the longline 3.

The hook with the bait 5 is transferred from the baiting machine 6 to the holder 8 via a conductor casing. The conductor casing involves a slot open at the top which is sufficiently wide to let the snood run through, so that the snood can then pull the hook/bait 5 inside the conductor casing 7.

When the piston 11 with the assembled holder 8 is in a retracted position, the end opening of the conductor casing is level with the opening 25 into the chamber in the holder 8. The tension on the longline 7 and the snood 4 pulls the hook/bait out of the conductor casing and directly into the chamber 26 in the holder 8, as the snood 4 runs through the slot 17 while the hook stem with the hook eye remains in the slot 27. Even if the holder is open at the bottom, the tension on the snood will be sufficient to keep the hook/bait in position inside the chamber 26. The hook/bait can now only be removed from the holder by pulling it vertically down through the slots 17/27.

A sensor 10 connected to the holder 8 records when the hook with bait 5 is inside the holder 8 and starts the movement of the piston 11 on which the end of the holder Is arranged, and which moves the holder 8 forwards towards the upper side of the edge of the container 12. Simultaneously, the longline disc 1 pulls the longline 3, which creates a slight tension on the longline 3. The tight snood 4 also helps move the holder 8 forwards towards the container with the hook/bait attached to the holder.

It is important that the holder 8 is positioned so as to ensure continued tension on the snood 4 when the hook with bait 5 enters the holder 8, i.e. that the connector 9 between the snood 4 and the longline 3 is in front of (upstream) from the longline disc 1. When the connector 9 passes the longline disc, it changes direction from horizontal to vertical, and will temporarily ease the tension on the hook/bait in the holder.

When the piston 11 has reached its end position, the holder has been pushed forwards towards the container so that it is level with and lies on top of a fixed conductor casing 13 which is placed over the container 12.

An ejector is arranged over the edge of the container to push the hook/bait 5 downwards and out of the holder 8. This ejector device starts when the piston 11 has reached its end position.

The ejector device involves a second cylinder 14 with a piston 15 and pushes the hook with bait 5 out of the holder 8, down through a subjacent conductor casing 13 and into a bait receptacle 16 to the container 12. The cells of the bait receptacle 16 are evenly distributed around the edge of the container 12. The longline 3 coils itself in the rope receptacle 17 In the container 12.

The conductor casing 13 also has two mutually level, vertical, run-through slots 18, 28 (detail D) through which the snood 4 and the piston 15 pass. The conductor casing 13 is positioned directly under the bottom-less holder 8 and so that the slots 17, 27 and 18, 28 are level. The second conductor casing 13 will also help stabilise the holder 8 when the piston 15 is moved downwards and pushes the hook/bait inside the holder 8.

On the bottom end of the piston 14¹, the actual ejector device 15 is shaped like an extended blade which is slightly thinner than the width of the slots 17, 27 and 18, 28 respectively. The blade is assembled standing edgewise so that when it is pushed down, it will fit precisely through the slots 17, 27 and 18, 28 respectively.

The ejector device/blade 15 operates to push the hook/bait in front of it and out of the holder, through the conductor casing and down into one of the storage cells 161 for the bait When the hook/bait has been stored, the blade 15 has reached its lowest position and is then retracted through the conductor casing 13. Simultaneously, the holder 8 on the end of the piston 11 has already been retracted to pick up a new hook with bait 5 as described above.

The longline container 12 is circular and involves a rope/longline receptacle 17 in the centre and a ring-shaped external receptacle 16, which is divided by radial partition walls into a number of hook/bait cells 16 for hook/bait 5. The inner wall in each bait cell 16′ involves a vertical slot 29 through which the snood can run.

Below, the different steps for the execution of the process of transferring from baiting machine to longline container shall be studied in brief, with reference to the figures.

FIGS. 1 to 3 illustrate the hook with bait 5 directly before it enters the holder 8.

FIG. 4 illustrates the hook with bait 5 once it has entered the holder 8. It is important to note that the connector 9 between the snood 4 and the longline 3 is in front of the longline disc 1 so that there is pulling tension on the snood 4. The sensor 10 records that the hook/bait is in position and starts movement of the cylinder 11.

FIG. 5 illustrates when the cylinder 11 for the holder 8 has started and is moving. As the cylinder moves, the tension on the snood 4 will decrease as the connector 9 has moved out of the longline disc 1.

FIG. 6 illustrates when the cylinder 11 has reached its end position. The holder 8 has now moved above the conductor casing 13, and the cylinder 14 with piston 15 is ready to start pushing the hook with bait 5 down into the bait receptacle 16 in the container 12.

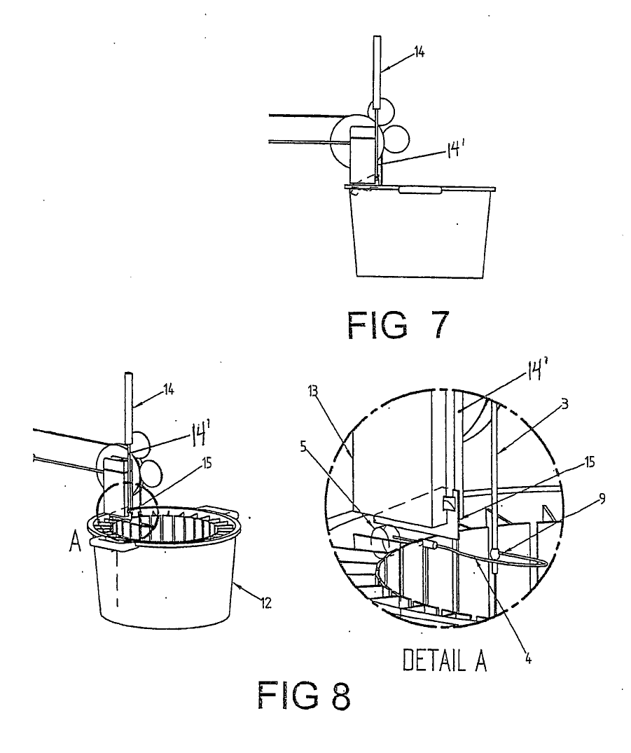

FIGS. 7 and 8 illustrate when the cylinder 14 with piston 15 have pushed the hook with bait 5 out of the holder 8, through the conductor casing 13 and down into the bait receptacle 16 In the container 12. The central rope/longline receptacle is illustrated as position 17 in FIG. 2.

When the piston 15 has pushed the hook with bait 5 out of the holder 8, the cylinder 11 can return to its start position for positioning of a new hook with bait 5 in the holder 8. When the cylinder 14 has reached its end position, it returns. The operation of transferring a hook with bait down into a container with separate receptacles for bait has now been completed, and the system is ready for a new operational cycle.

The container 12 is positioned on an indexable rotating table (not illustrated), so that the container can rotate round to a new bait cell 16′ once a certain number of hooks 5 have been transferred into the bait receptacle 16′.

This invention represents a significant improvement in the automation of the baiting process for longline with snood.

1. Method for transferring longline hooks with bait (5) from a baiting machine (6) to a longline container (12), where each hook is fastened to the longline (3) via snood (4), and the longline is set up to be arranged in a longline receptacle (37) in the longline container (12) while the hook/bait (5) is arranged in a hook/bate receptacle (16) adjacent to the longline receptacle (37), characterised in that simultaneously to the longline (3) being conducted mainly horizontally from the baiting machine via a conductor disc and down into the longline receptacle (37), the hook with bait (5) is transferred in an initial manoeuvre into a holder (8), and the holder is transferred mainly horizontally to an end position directly above the longline container (12), and then an ejector device (15) transfers the hook with bait (5) out of the the holder (8) and downwardly into the hook/bait receptacle (16) of the longline container (12).

2. Method according to claim 1, characterised in that the hook/bait is pulled into the holder (8) through a first conductor casing (7) permanently fixed to the baiting machine (6), where the snood (4) runs through a slot in said first conductor casing (7), and the exit of the hook/bait (5) from the conductor casing (7) is level with the corresponding entrance to the holder (8).

3. Method according to claims 1-2, characterised in that when the holder (8) is in its end position above the longline container (12), an ejector device (15) pushes the hook/bait (5) out of the holder and downwardly through a second conductor casing (13) into the bait receptacle (16).

4. Method according to any of preceding claims, characterised in that the holder (8) movement to said end position is provided by operating a piston/cylinder unit, the holder (8) being assembled to the piston rod.

5. Method according to any of preceding claims, characterised in that the movement of the holder is assisted by the tension on the snood (4) via the longline (3) running over the conductor disc (1).

6. Method according to any of preceding claims, characterised in that the hook/bait (5) is placed in the holder (8) by pulling be snood through one of the vertical, run-through, straight-through slots in the peripheral wall (22) of the holder, but through which the hook/bait (5) cannot pass.

7. Method according to any of preceding claims, characterised in that the a holder with open bottom is used and that the hook/bait is pushed vertically out and down through the open holder bottom, as the snood is pushed down and out of the slot (17, 27).

8. Method according to any of preceding claims, characterised in that the the hook/bait (5) and the snood (4) are transferred to the longline container from the holder via the second conductor casing (13) which involves vertical, run-through slots (18, 28) and a duct, for which the cross-section corresponds to the cross-section of the slots (17, 27) and the chamber (26), respectively, of the holder (8).

9. Method according to one of the preceding claims, characterised in using an indexable rotating table so that the longline container (12) rotates round to a new bait cell (16¹) once a certain number of hooks with bait (5) have been transferred to the bait receptacle (18¹).

10. Device for transferring longline hooks with bait (5) from a baiting machine (6) to a longline container (12), where each hook is fastened to the longline (3) via a snood (4), and the longline is set up to be arranged in a longline receptacle (37) in the longline container (12) while the hook/bait (5) is arranged to be placed in a hook/bait receptacle (16) adjacent to the longline receptacle (37), characterised in that the device comprises;
a holder (8) to capture the hook with bait (5) from the baiting machine, said holder (8) being arranged to be conducted mainly in a horizontal direction to an end position, directly above the longline container (12), and
an ejector device (15) to transfer the hook with bait (5) out of the holder (8) and downwardly into the hook/bait receptacle (16) of the longline container (12).

11. Device according to claim 10, characterised in that the holder (8) for the hook/bait (5) is assembled to the piston rod (11) of a piston/cylinder unit which is arranged to move the holder (8) to said end position.

12. Device according to any of claims 10-11, characterised in that the holder (8) is made up of plates to form a housing with open top and bottom, and a flap to which the end of the piston rod (11) is assembled, and the peripheral wall (22) involves straight-through vertical run-through slots (17, 27) through which the snood (14) is arranged to run, while the inner and (25) of the housing is also open and forms an entrance to the holder (8).

13. Device according to claims 10-12, characterised in that a first conductor casing (7) for hook/bait (5) is permanently fixed to said baiting machine (6) and involves a longitudinal slot through which the snood (4) can run, as the exit from the hook/bait (5) from the conductor casing (7) is level with the above-mentioned opening (25) to the holder (8) when the piston rod (11) is in retracted position.

14. Device according to any of the preceding claims 10-13, characterised in that the hook/bait (5) and the snood (4) are transferred from the holder (8) to the longline container (12) via a second conductor casing (13) which involves vertical run-through slots (18, 28) which are level with the older slots (17, 27).

15. Device according to any of the preceding claims 10-14, characterised by a second conductor casing (13) including vertical run-through slots (18, 28) and a duct with a cross-section which are level/equivalent with the cross-section of the slots (17, 27) and the chamber (26), respectively, in the holder, when the holder (8) at its end position is level with the conductor casing (13).

16. Device according to any of the preceding claims 10-15, characterised in that the longline container (12) is arranged on an indexable rotating table that may rotate the container (12) around to a new bait cell (16¹) once a certain number of hooks with bait (5) have been transferred into the bait receptacle (16¹).
